(19) United States
(12) Patent Application Publication
(10) Pub. No.: US 2003/0185106 A1
(43) Pub. Date: Oct. 2, 2003

(54) Clock with centrally rotating dynamic lighted picture effect

(75) Inventor: Deping Zhu, Shanghai (CN)

Correspondence Address: PHILIP K. YU, 20955 PATHFINDER ROAD, SUITE 160, DIAMOND BAR, CA, 91765, US

(73) Assignee: New Continental International Corp.

(21) Appl. No.: 10/167,550

(22) Filed: Jun. 11, 2002

(30) Foreign Application Priority Data
Mar. 28, 2002 (CN) 02216432.4

(51) Int. Cl. G04C 17/00; G04B 19/00; G04B 25/00

(52) U.S. Cl. 368/223

(57) ABSTRACT

A decorative clock with dynamic lighted picture is disclosed. The hands of the clock revolves around a central axle, which is connected to the clock mechanism. The rotatable polarizing disk for producing the dynamic picture effect revolves by a hollow spindle, through which the clock's central axle is positioned. As such, the polarizing disk rotates without affecting the movement of the hands of the clock. The polarizing disk and the hollow spindle are driven by a drive wheel, which is driven by another drive wheel and a motor installed away from the clock. The drive wheels are engaged through a drive belt. Therefore, both the clock and the polarizing disk can operate independently, and the dynamic lighted picture effect can be projected onto the clock.

### FIELD OF THE INVENTION

The present invention relates to decorative clocks and more specifically to clocks with a decorative background display.

### ART BACKGROUND

A conventional dynamic lighted picture is a frame of a picture, e.g. a scenery picture, which has a polarizing rotating disk and a lamp installed underneath. Certain portions of the scenery picture is made of polarized sheet. By shining the light through the polarizing rotating disk to the polarized sheet, it creates a visual effect on the outside that those portions of the picture has moving parts. For example, a waterfall on the picture may appear as if it were actually moving, by virtue of the dynamic picture effect of shining the light through the polarizing disk underneath the waterfall portion.

To make a dynamic lighted picture more functional, some have combined a clock with this dynamic picture frame. Conventionally, this combination, as shown in FIG. 1, is achieved by installing a timer 10, or clock mechanism, near one corner of a rectangular picture frame 11. Timer 10 will operate the hands on the top surface of picture frame 11. The dynamic, or rotation, mechanism 12, can then be installed elsewhere, underneath polarized picture 13. Since both the clock mechanism 10 and the dynamic mechanism 12 both take up room inside picture frame 11, dynamic mechanism 12 cannot be at the same position as clock 10. The net effect is that while the picture on clock portion remains static, the dynamic portion 13 must separately appear elsewhere on the picture frame.

Efforts to provide dynamic effects even for clock mechanism 10 have been undesirable, largely due to the independent and separate functionality of the clock mechanism 10 and the dynamic mechanism 12. The requirement and characteristics of clock mechanism 10 and dynamic mechanism 12, as well as their structural limitations, not only make the dynamic picture unable to produce visual effect, but also compromise the effect of the picture as a whole. The reality is that the two functions exist independently in two forms and they lack compatibility.

Therefore, it is desirable to provide a dynamic lighted picture effect also for the clock portion.

It is also desirable to be able to provide dynamic lighted picture effect with the clock without affecting the operation of the clock.

It is further desirable to be able to provide dynamic lighted picture effect without regard to the location of the clock.

### SUMMARY OF THE INVENTION

A decorative clock with dynamic lighted picture is disclosed. The hands of the clock revolves around a central axle, which is connected to the clock mechanism. The rotatable polarizing disk for producing the dynamic picture effect revolves by a hollow spindle, through which the clock's central axle is positioned. As such, the polarizing disk rotates without affecting the movement of the hands of the clock. The polarizing disk and the hollow spindle are driven by a drive wheel, which is driven by another drive wheel and a motor installed away from the clock. The drive wheels are engaged through a drive belt. Therefore, both the clock and the polarizing disk can operate independently, and the dynamic lighted picture effect can be projected onto the clock.

### BRIEF DESCRIPTION OF THE DRAWING

FIG. 1 is an exemplary diagram of a conventional clock with dynamic lighted picture combination.

FIG. 2 is an exemplary diagram of a drive unit for a centrally rotating dynamic lighted picture in accordance with one embodiment of the present invention.

### DESCRIPTION OF THE PREFERRED EMBODIMENT

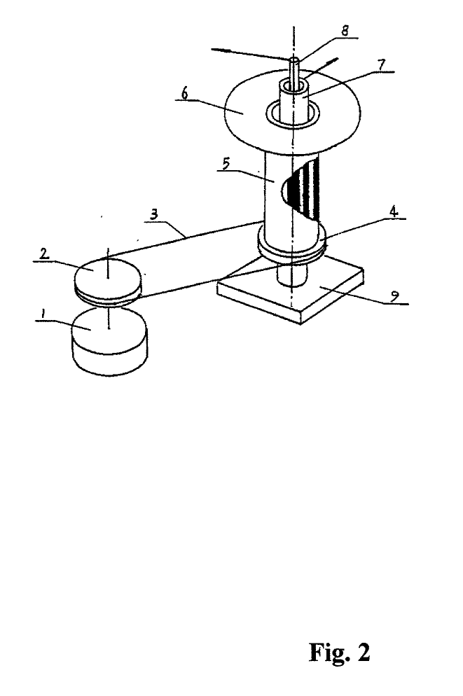

Referring to FIG. 2, the structure of the centrally rotating dynamic lighted picture in accordance with one embodiment of the present invention is illustrated. In the center of timer mechanism 9 are spindles 7, 8 for the hour hand and minute hand, respectively. Hollow revolving spindle 5 of the polarizing disk 6 (partially shown) is an independent revolving axle with the hands' spindles 7, 8 passing through its middle, hollow portion. The hollow spindle 5 is coaxial with the hands' spindles 7, 8.

Motor 1, currently implemented with an AC-powered motor, for rotating polarizing disk 6 is installed away from timer mechanism 9. Power from motor 1 is transferred to hollow revolving spindle 5, and hence polarizing disk 6, through drive belt 3. Those skilled in the art may appreciate that the hand spindles 7, 8 need to have a clearance from the inside wall of the hollow revolving spindle, to prevent their interference with hollow revolving spindle 5.

It should be appreciated by those skilled in the art that hollow revolving spindle 5 allows timer mechanism 9 to co-locate with polarizing disk 6 such that the base cover of the clock can also achieve dynamic lighted picture. Although the spindles are co-located, the clock and the polarizing disk have independent operations. As such, the dynamic lighted picture effect can be achieved even on the clock's base cover.

Exemplary Physical Realization.

One exemplary embodiment in accordance with the present invention can be realized as follows.

Hand spindles of timer. The hour and minute hand spindles of the clock are made to be longer than conventional spindles to accommodate the various components. The conventional second, minute and hour hand spindles in a conventional electronic timer mechanism are replaced by the now-extended minute and hour hand spindles. Also, it should be noted that a second hand spindle may be implemented to allow a second hand to operate.

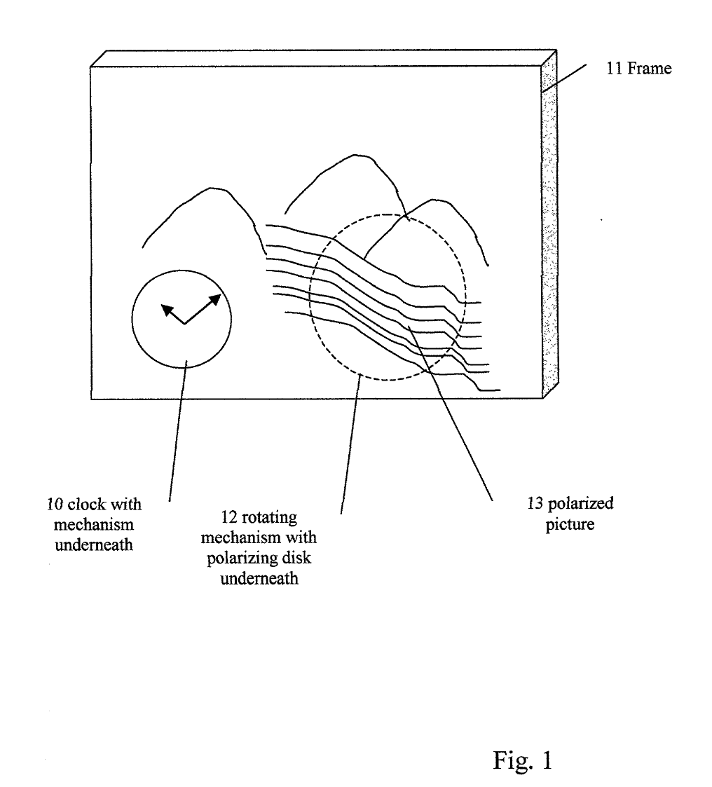

Polarizing disk and clock drive mechanism. The major components for the centrally rotating mechanism are motor 1, drive wheel 2, drive belt 3, drive wheel 4, hollow revolving spindle 5, polarizing disk 6, hour hand spindle 7, minute hand spindle 8, timing mechanism 9. These components can all be installed within the housing of a clock frame or a picture frame with a clock thereon. Motor 1 is fixed on the inside of the housing. Drive wheel 2 is mounted on motor spindle and fixed with screw and spring. Drive belt 3 is mounted into the grooves of drive wheels 2 and 4. Drive wheel 4 is mounted on the lower end of hollow revolving spindle 5 and fixed with screw. Polarizing disk 6 is mounted on the upper end of hollow revolving spindle 5. Drive wheel 4, polarizing disk 6 and hollow revolving spindle 5 are engaged as one unit. Hand spindles of timer 9 are mounted into the opening of hollow revolving spindle 5. Timing mechanism 9 is mounted within the housing, but separated from motor 1. Minute and hour hands (not shown) are mounted on minute hand spindle 8 and hour hand spindle 7, respectively. It should be noted that with the central rotating teaching of the present invention, even the conventional picture frame as shown in FIG. 1 can be provided with dynamic lighted picture effect. Therefore, the present invention is not limited to just a clock as a stand-alone unit, but also can be applied to clocks as part of the picture frame.

Operation:

(1) Rotation of Polarizing Disk Produces Dynamic Effect

When power is supplied to motor 1, its spindle rotates and drives drive wheel 2, drive belt 3, drive wheel 4, hollow revolving spindle 5, and polarizing disk 6. Currently, drive wheels 2 and 4 are of the same size so that the polarizing disk 6 rotates synchronously with motor 1. Of course, those skilled in the art may design the drive wheels to be of different dimension to variable rotation. The rotation of polarizing disk 6 will interact with the static polarizing strip on the picture of the clock to produce continuously changing transmittance and dynamic effect of flowing water on picture under lamp illumination. In a current embodiment, the motor is powered by AC currents.

(2) Timing

When battery power is placed into the timing mechanism, the drives of the minute hand spindle 8 and hour hand spindle 7 begin to operate. When minute and hour hands are mounted to their respective spindles, they can show promptly time in hour and minute.

Although the invention is described herein with reference to the preferred embodiment, one skilled in the art will readily appreciate that other applications may be substituted for those set forth herein without departing from the scope of the present invention. Accordingly, the invention should only be limited by the claims included below.

What is claimed is:

1. A rotation device for a clock with dynamic lighted picture, comprising:
a motor;
a timer unit to operate said clock;
a hollow spindle coupled to said timer unit;
a polarizing disk coupled to said hollow spindle;
a drive unit, engaging said motor and said hollow spindle to rotate said hollow spindle as driven by said motor;
a hour hand spindle, adapted to rotate within said hollow spindle;
a minute hand spindle, adapted to rotate with said hour spindle.

2. The rotation device of claim 1, wherein said motor is installed separately from said timer unit.

3. The rotation device of claim 2, wherein said polarizing disk is coupled to one end of said hollow spindle and said timer is coupled to said hollow spindle at another end.

4. The rotation device of claim 3, wherein said driver unit comprises:
a first drive wheel coupled to said motor;
a second drive wheel coupled to said hollow spindle;
a drive belt to engage said first and second drive wheels.

5. The rotation device of claim 4, wherein said first drive wheel and said second drive wheel are of the same diameter.

6. A clock with dynamic lighted picture, comprising:
a housing;
a static polarized picture on one face of said housing;
a timer unit within said clock housing, adapted to operate a clock, comprising:
a hour hand on said static polarized picture;
a minute hand on said static polarized picture;
a hour spindle to drive said hour hand;
a minute spindle, coaxially located within said hour spindle, to drive said minute hand;
a rotation unit coupled to said housing, comprising:
a motor, adapted to rotate a predetermined speed;
a first drive wheel coupled to said motor;
a second drive wheel;
a drive belt to engage said first and second drive wheel;
a hollow revolving spindle coupled to said second drive wheel, said hour and minute spindles being adapted to be coaxially located with said hollow revolving spindle;
a polarizing disk coupled to one end of said hollow revolving spindle, driven by said hollow revolving spindle to rotate at a predetermined speed, and a light source adapted to project light to said static polarized picture through said polarizing disk.

7. The clock of claim 6, wherein said first drive wheel and second drive wheel have a one-to-one ratio in diameter.

8. A decorative picture frame, comprising:
a housing;
a light source within said housing;
a clock surface on top of said housing, comprising a static polarized picture, an hour hand and a minute hand;
timer means mounted in said housing, for operating said hour and minute hands;
a polarizing disk underneath at least a portion of said static polarized picture;
a hollow spindle adapted to rotating said polarizing disk at said polarizing disk's center,
hand spindles coupled to said timer means, said hand spindles being adapted to rotate within said hollow spindle;
drive means for driving said hollow spindle.

9. The clock of claim 8, wherein said drive means comprises:
a motor, mounted inside said housing and away from said timer means;
a first drive wheel driven by said motor;
a second drive wheel coupled to said hollow spindle;
a drive belt for engaging said first and second drive wheels.
